(19) United States
(12) Patent Application Publication
(10) Pub. No.: US 2017/0298846 A1
(43) Pub. Date: Oct. 19, 2017

(54) DIESEL ENGINE COMBUSTION AND TEMPERATURE MANAGEMENT SYSTEM

(71) Applicant: FIRE CHARIOT, LLC, Rochelle, IL (US)

(72) Inventor: Jeffrey A. BRUE, Dixon, IL (US)

(21) Appl. No.: 15/582,925

(22) Filed: May 1, 2017

Related U.S. Application Data
(63) Continuation of application No. 14/700,309, filed on Apr. 30, 2015, now abandoned.
(60) Provisional application No. 61/986,493, filed on Apr. 30, 2014.

(51) Int. Cl. F02D 41/00; F02D 19/02; F02B 7/04; F02M 35/10; F02M 25/00; F02D 41/26; F02D 19/08

(52) U.S. Cl. CPC F02D 41/0025; F02M 25/00; F02D 19/02; F02D 41/26; F02B 7/04; F02M 35/10209; F02M 35/10019; F02D 19/081; Y02T 10/32; Y02T 10/36

(57) ABSTRACT

A diesel engine combustion and temperature management system includes injection nozzles for injecting plural fuel additives into an intake of the diesel engine and a controller controlling the amount of each fuel additive injected as a function of engine load, engine speed, exhaust temperature, and/or other parameters.

### CROSS-REFERENCE TO RELATED APPLICATIONS

This application is a Continuation of co-pending U.S. application Ser. No. 14/700,309, filed Apr. 30, 2015, which claims benefit of U.S. Provisional Patent Application No. 61/986,493, filed on Apr. 30, 2014, and incorporates by reference the disclosure thereof in its entirety.

### BACKGROUND OF THE DISCLOSURE

The present disclosure is directed to a system and method for improving the operating efficiency and/or performance of a diesel engine. More specifically, the present disclosure is directed to a system including injection nozzles configured to inject fuel additives into a combustion air intake system of a diesel engine and a controller for controlling the amount of additives injected.

### BRIEF DESCRIPTION OF THE DRAWINGS

FIG. 1 is a block diagram showing a diesel engine equipped with an illustrative diesel engine combustion and temperature management system;

FIG. 2 is a schematic diagram showing illustrative additive injectors;

FIG. 3 is a perspective view of an illustrative additive injection module;

FIG. 4 is a side view of an illustrative additive injection module;

FIG. 5 is a cross-sectional top plan view of an illustrative additive injection module;

FIG. 6 is an end view of an illustrative additive injection module;

FIG. 7 is an end view of an illustrative additive injection module having additive injectors disposed therein;

FIG. 8 is a view of an illustrative control/display panel for controlling and monitoring the status of the system;

FIG. 9 is a view of another illustrative control/display panel for monitoring the status of the system;

FIG. 10 is an illustrative methanol injection look up table;

FIG. 11 is an illustrative LP injection look up table;

FIG. 12 is a side view of an illustrative LP injector;

FIG. 13 is a side view of an illustrative methanol injector, and

FIG. 14 is a further illustrative methanol injection look up table and a further illustrative LP injection look up table.

### DETAILED DESCRIPTION OF THE DRAWINGS

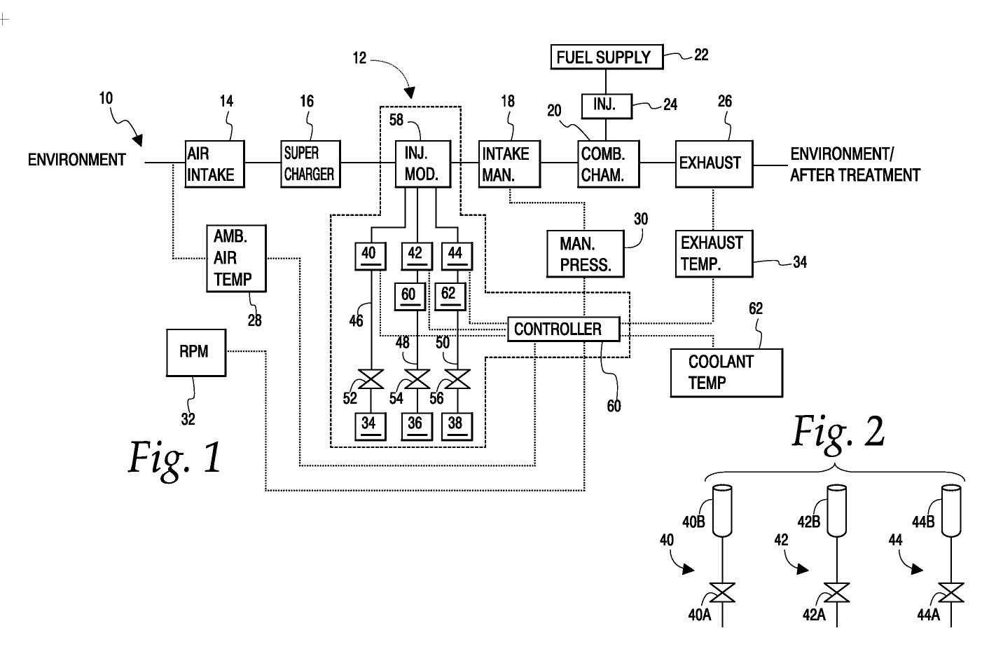

FIG. 1 is a block diagram showing an illustrative diesel engine 10 equipped with an illustrative diesel engine combustion and temperature management system 12. The diesel engine 10 may be a conventional diesel engine having any number (one or more) of cylinders. The diesel engine 10 may be installed in a vehicle, for example, an automobile, truck, boat or ship, or it may be installed in a stationary application.

The illustrative diesel engine 10 includes a combustion air intake system including an air intake 14, a supercharger (for example, a turbo-supercharger or turbocharger) 16, and an intake manifold 18. The air intake 14 provides combustion air from the environment to the supercharger 16. The supercharger 16 pressurizes the combustion air and provides it to the intake manifold 18. The intake manifold 18 distributes the combustion air to the individual cylinders 20 of the diesel engine 10 via a combustion air intake port and valve(s). The diesel engine 10 may include any number of cylinders, for example without limitation, four, six, eight, or sixteen cylinders. Only one cylinder 20 is shown in FIG. 1 for clarity.

The illustrative diesel engine 10 also includes a fuel system including a fuel injector 24 for each cylinder 20 and a fuel supply 22 providing fuel to each fuel injector. The fuel system selectively provides diesel fuel or another suitable fuel from the fuel supply 22 to each cylinder 20 of the diesel engine 10 via the corresponding fuel injector 24. The fuel and combustion air are combusted in the cylinder. An exhaust system 26 receives exhaust gases from the cylinder 20 via an exhaust valve and port and carries them to the environment and/or an after-treatment system. In embodiments where the supercharger 16 is a turbo-supercharger, the exhaust system 26 may be connected to the turbine side thereof to enable the exhaust gases to drive the impeller thereof.

The illustrative diesel engine 10 may be equipped with sensors, for example, without limitation, an ambient air temperature sensor 28, an intake manifold pressure sensor 30, an engine speed sensor (tachometer) 32, an exhaust temperature sensor 34, a coolant temperature sensor 62, and an altitude or ambient barometric pressure sensor (not shown). Such sensors would be configured to sense the respective engine and/or environmental parameters and provide an output signal indicative of same for use by an engine management system, the illustrative system 12, and/or other components.

The illustrative system 12 includes one or more additive subsystems for selectively providing one or more fuel additives to the combustion air intake system of the diesel engine 10. Each additive subsystem may include an additive tank, an additive injector, and an additive conduit in fluid communication with the respective additive tank and additive injector for conveying the additive from the additive tank to the additive injector. An additive isolation valve may be provided, for example, in the additive conduit to isolate the additive tank from the additive injector. The additive isolation valve may be equipped with any suitable form of operator, for example, without limitation, a manual operator, a solenoid operator, an electric operator, or an air operator. The additive isolation valve, where provided, typically would be located at the respective additive tank or in the fluid conduit relatively near the additive tank. Each additive subsystem may be provided with one or more sensors for detecting the respective subsystem tank fill level and/or the respective additive subsystem pressure at the additive tank and/or the additive injector(s) and/or there between, for example, in the additive conduit.

FIG. 1 shows an illustrative system 12 having three additive subsystems, namely, an ether subsystem for providing liquid ether (which may be referred to herein as “ether”) to the diesel engine combustion air intake system, a methanol subsystem for providing liquid methanol or a mixture of liquid methanol and water (which may be referred to herein interchangeably as “methanol”) to the diesel engine combustion air intake system, and a liquid propane (LP) or liquified petroleum gas (LPG) (which may be referred to interchangeably herein as “LP”) subsystem for providing LP to the diesel engine combustion air intake system. Other embodiments may include additional ether, methanol, and/or LP subsystems and/or other additive subsystems. These additives typically would be stored in the respective additive tanks in liquid form.

The ether subsystem shown in FIG. 1 includes an ether tank 34, an ether injector 40, an ether conduit 46 coupling the ether tank to the ether injector, and an ether isolation valve 52 for selectively isolating the ether tank from the ether injector. In an embodiment, an ether pump (not shown) could be provided in the ether subsystem between the ether tank 34 and the ether injector 40 to boost the ether pressure to a level greater than the ether tank pressure (which may fluctuate based on ambient temperature, the mass of ether in the ether tank, and other factors). The ether subsystem may be operated, for example, with liquid ether pressurized to about 20-180 psi or a lesser or greater pressure at the ether injector.

The methanol subsystem shown in FIG. 1 includes a methanol tank 36, a methanol pump 60, a methanol injector 42, a methanol conduit 48 coupling the methanol tank, methanol pump and methanol injector, and a methanol isolation valve 54 for selectively isolating the methanol tank from the methanol injector. The methanol pump 60 may be configured to provide methanol to the methanol injector 42 under pressure, for example, at pressures of 170-200 psi or a lesser or greater pressure.

The LP subsystem shown in FIG. 1 includes an LP tank 38, an LP pump 62, an LP injector 44, an LP conduit 50 coupling the LP tank, LP pump, and LP injector, and an LP isolation valve 56 for selectively isolating the LP tank from the LP injector. The LP pump 62 may be configured to boost the pressure of the LP provided to the LP injector 44 from LP tank pressure (which may fluctuate based on ambient temperature, the mass of LP in the LP tank 38, and other factors) to a greater pressure, for example, a pressure of 50-180 psi or a lesser or greater pressure. In an embodiment, the LP pump 62 could be omitted.

The additive subsystems shown in FIG. 1 include one additive injector per additive subsystem. Other embodiments could include more than one additive injector per subsystem. For example, any or all of the additive subsystems could include two or more additive injectors. The two or more additive injectors in a given subsystem could have substantially the same flow characteristics. Alternatively, two or more of the additive injectors in a given subsystem could have substantially different flow characteristics. The desired flow characteristics could be achieved, for example, by sizing the injectors as desired, as discussed further below. The injector sizing and desired flow characteristics could be a function of factors such as engine displacement, additive supply pressure (tank pressure or post-pump pressure), altitude (or ambient atmospheric pressure), and temperature, among others.

In an embodiment including two additive injectors per additive subsystem, a first of the additive injectors (sometimes referred to herein as a “stage 1” injector) could be configured to inject the additive at a first flow rate and a second of the additive injectors (sometimes referred to herein as a “stage 2” injector) could be configured to inject the additive at a second flow rate, with other relevant parameters, for example, additive pressure and temperature, being equal. Such first and second additive injectors could be independently controlled such that the additive could be injected at first flow rate when the first additive injector is valved in (or “on”) and the second additive injector is valved out (or “off”). The additive could be injected at a second flow rate when the second additive injector is “on” and the first additive injector is “off.” The additive could be injected at a third flow rate when both the first and second additive injectors are “on.” Thus, three different additive flow rates can be provided for using two additive injectors, each having different flow characteristics.

Similarly, seven different additive flow rates could be provided for using three additive injectors, each having different flow characteristics, and so on.

Each additive injector 40, 42, 44 may include an injection valve and an injection nozzle (the injection nozzles may sometimes be referred to herein as “atomizers”), the injection nozzle having an inlet and an outlet (or orifice). The injection valve and injection nozzle could be separate structures, or they could be combined into a unitary structure. FIG. 2 shows illustrative ether, methanol, and LP injectors, wherein ether injector 40 includes an ether injector injection valve 40A and an ether injector injection nozzle 40B, methanol injector 42 includes a methanol injector injection valve 42A and a methanol injector injection nozzle 42B, and LP injector 44 includes an LP injector injection valve 44A and an LP injector injection nozzle 42B.

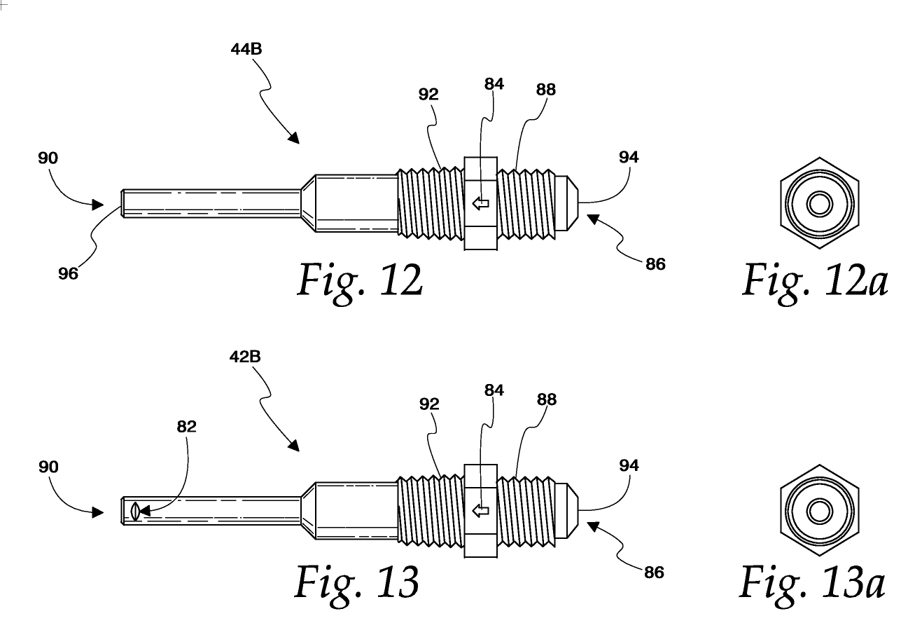

FIG. 12 shows an illustrative LP injection nozzle 44B. The LP injection nozzle 44B includes an inlet end 86 having a threaded portion 88, an outlet end 90 having a threaded portion 92, and wrench flats 94 intermediate the threaded portions 88, 92. The inlet end threaded portion 88 may be configured to mate with a threaded coupling on the corresponding LP conduit 50. The outlet end threaded portion 92 may be configured to engage with a threaded portion of an additive injection module 58, as will be discussed further below. The LP injector 44B defines a generally annular fluid passage extending from the inlet end 86 to the outlet end 90. The inlet end 86 of the LP injection nozzle 44B defines an inlet port 94 into which LP may be received from LP conduit 50. The outlet end 90 of the LP injection nozzle 44B defines an outlet port or orifice 96 through which LP may be injected into the additive injection module 58 as will be discussed further below.

The LP injection nozzle 44B orifice sizes may vary based on engine displacement and whether used as a stage 1 or stage 2 (or other stage) nozzle. In illustrative embodiments, the LP injection nozzle orifices may be generally circular orifices sized as set forth in Table 1 below.

TABLE 1

| | | Orifice size |
|---|---|---|
| Engine size | Stage | (diameter) |
| 5.9 liter | 1 | 0.013 inch |
| | 2 | 0.018 inch |
| 13 liter | 1 | 0.021 inch |
| | 2 | 0.026 inch |
| 15 liter | 1 | 0.026 inch |
| | 2 | 0.031 inch |

The orifice sizes set forth in Table 1 are illustrative only and could vary for a given engine displacement as well as for engines of different displacements. Also, the orifices could have shapes other than generally circular.

The ether injection nozzle 40B may be similar to the LP injector nozzle 44B, although it may have a different orifice size and/or shape.

The methanol injection nozzle 42B may be similar to the LP injection nozzle 44B, although it may have a different orifice size and/or shape. For example. FIG. 13 shows an illustrative methanol injection nozzle 42B including an orifice in the form of a “whisper cut” 82 instead of the outlet port or orifice described in connection with the LP injection nozzle 44B. As such, the outlet end 90 of the methanol injection nozzle 42B as illustrated in FIG. 13 is closed off. In another embodiment, the methanol injection nozzle 42B may include both the whisper cut 82 and an outlet port or orifice as described in connection with the LP injection nozzle 44B or only the outlet port or orifice as described in connection with the LP injection nozzle 44B and not the whisper cut 82.

The whisper cut 82 may be shaped to promote atomization of methanol injected there through regardless of the cross-sectional area of the opening defined thereby. Typically, the whisper cut 82 would comprise a narrow slit in the sidewall of the methanol injection nozzle 42B near the outlet end 90 thereof. In an embodiment, the whisper cut has a circumferential length of about 1/16 inch around the circumference of the body of the methanol injector nozzle proximate its outlet end 90, a height of about 0.002 inches, and a surface area of about 1.25×10⁻⁴ square inches. A whisper cut of this size may allow for a methanol flow rate of about 0.216 cc (cubic centimeter) per second at a methanol pressure of about 200 psi. The foregoing whisper cut sizing and configuration is illustrative. The whisper cut 82 may be sized larger or smaller and shaped differently than described above as may be desired for a particular application. For example, the whisper cut may be longer, shorter, wider, and/or narrower. Also, one or more additional whisper cuts 82 of the same or different size and/or shape may be provided on the methanol injection nozzle 42B as may be desired for a particular application. The whisper cut 82 is shown in FIG. 13 as being located near the outlet end of the methanol injector nozzle 42B. In other embodiments, one or more whisper cuts 82 may be located nearer to or farther from the outlet end of the methanol injection nozzle 42B.

Further, the orifice size (and/or whisper cut size) of any stage 1 injection nozzle may be different from the orifice size (and/or whisper cut size) of any stage 2 injector injection nozzles. Any or all of the injection nozzles may be marked with or otherwise include a flow direction arrow 84 signifying the intended additive flow direction through the nozzle.

The additive injection valves 40A, 42A, 44A may be provided with remotely controlled powered operators, for example, solenoid operators. Alternatively, they may be provided with other forms of powered operators, for example, those described above in connection with the additive isolation valves, or they may be manually operated.

The system 12 also includes an additive injection module 58. The additive injection module 58 is configured for fluid communication with the additive subsystems and the diesel engine combustion air intake system, and it functions as an interface between the additive subsystems and the diesel engine combustion air intake system. In the illustrative system 12 shown in FIG. 1, the additive injection module 58 is located in the diesel engine combustion air intake system between the supercharger 16 and the intake manifold 18, downstream of the supercharger and upstream of the intake manifold, and in fluid communication with the supercharger outlet and the intake manifold inlet. The additive injectors or portions thereof may be disposed in the additive injection module 58, as discussed further below. The injector nozzles may extend into the additive injection module so that the nozzle outlets extend into a combustion air flow path there through.

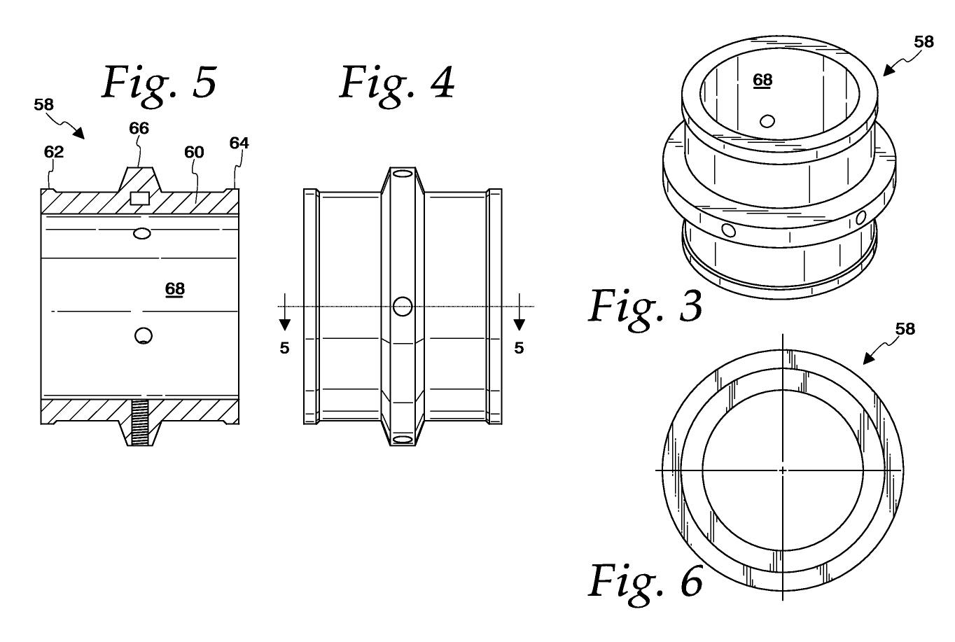

In an illustrative embodiment, as shown in FIGS. 3-7, the additive injection module 58 may take the form of an annular ring or sleeve having a body 60, an inlet flange 62 adjacent an inlet side of the body, an outlet flange 64 adjacent an outlet side thereof, and an injector-receiving boss 66 between the inlet side and outlet side thereof. The body 60 defines an interior region 68 through which combustion air flows when the diesel engine 10 is in operation. The injector-receiving boss 66 defines a number of apertures 70, each such aperture configured to receive at least a portion of a corresponding additive injector. As shown in FIG. 5, the apertures 70 may be threaded to receive correspondingly threaded portions of the respective additive injectors. In an embodiment, the additive injection module 58 and the additive injection nozzles 40B, 42B, 44B are configured to promote mixing of the additives in the intake air stream flowing through the additive injection module toward the intake manifold 18.

The additive injection module shown in FIGS. 3-7 includes five apertures 70 for receiving five injectors, namely, an ether injector 40, two methanol injectors 42 (one of which may be a stage 1 injector and the other of which may be a stage 2 injector), and two LP injectors 44 (one of which may be a stage 1 injector and the other of which may be a stage 2 injector). The five apertures 70 are shown as equally spaced about the circumference of the injector-receiving boss 66, but they need not be. Other embodiments could include more or fewer apertures, with the number of apertures corresponding to the number of additive injectors to be installed in the additive injection module 58. In any embodiment, the apertures 70 can be spaced about the injector-receiving boss 66 as desired.

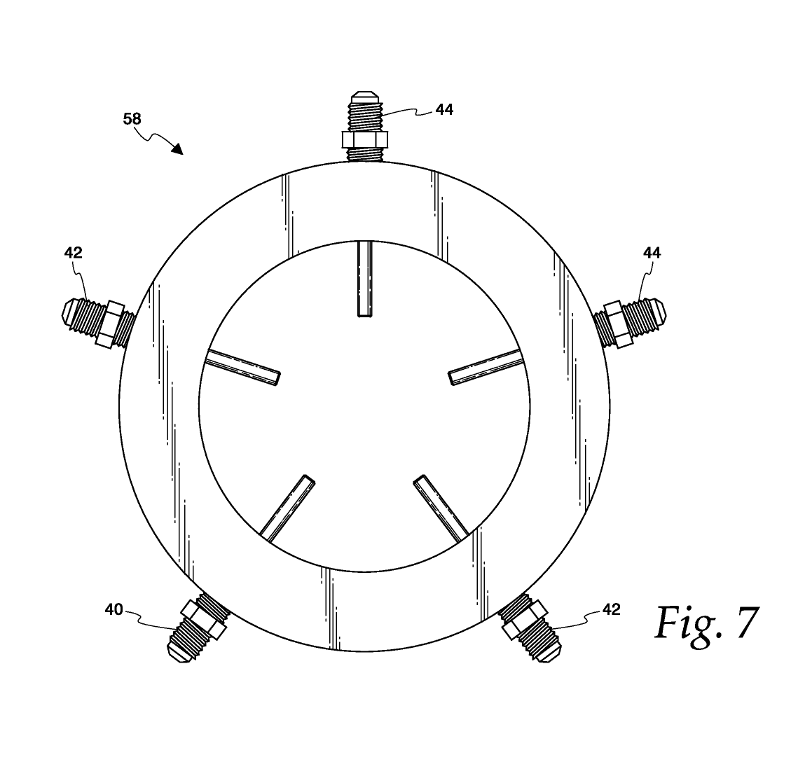

FIG. 7 shows the outlet ends of the injector nozzles 40A, 42A, 44A extending toward the center of the additive injection module 58. The outlet ends of the injection nozzles could extend into the additive injection module 58 a greater or lesser distance than shown. In an embodiment, the outlet ends of the injection nozzles could extend into the additive injection module 58 to a location that promotes mixing of the injected additives with the combustion air flowing through the additive injection module.

The additive injection module 58 may be connected to the supercharger 16 and the intake manifold 18 using conventional or other intake air conduits or boots. For example, a free end of a boot connecting the supercharger 16 to the additive injection module 60 could be slipped over the inlet side flange 62 and over the adjacent portion of the body 60 and secured thereto using a conventional hose clamp or other suitable means. Similarly, a free end of a boot connecting the intake manifold 18 to the additive injection module 60 could be slipped over the outlet side flange 64 and over the adjacent portion of the body 60 and secured thereto in a similar manner.

The illustrative system 12 shown in FIG. 1 includes an electronic controller 60. The controller may include, without limitation, a microprocessor and memory. The controller 60 may receive inputs from any or all of the engine, environmental, and subsystem sensors described above, and/or other sensors. The controller 60 may use the data provided from these sensors according to a predetermined algorithm to determine when the individual additive subsystem injection valves should be opened and closed to thereby regulate injection of the various additives. The controller may provide output signals to powered operators for the injection valves to open and close the injection valves. (In an embodiment, the controller 60 could be omitted or replaced with a non-electronic controller, and the additive subsystem injection valves could be opened and closed manually according to a predetermined algorithm or otherwise.)

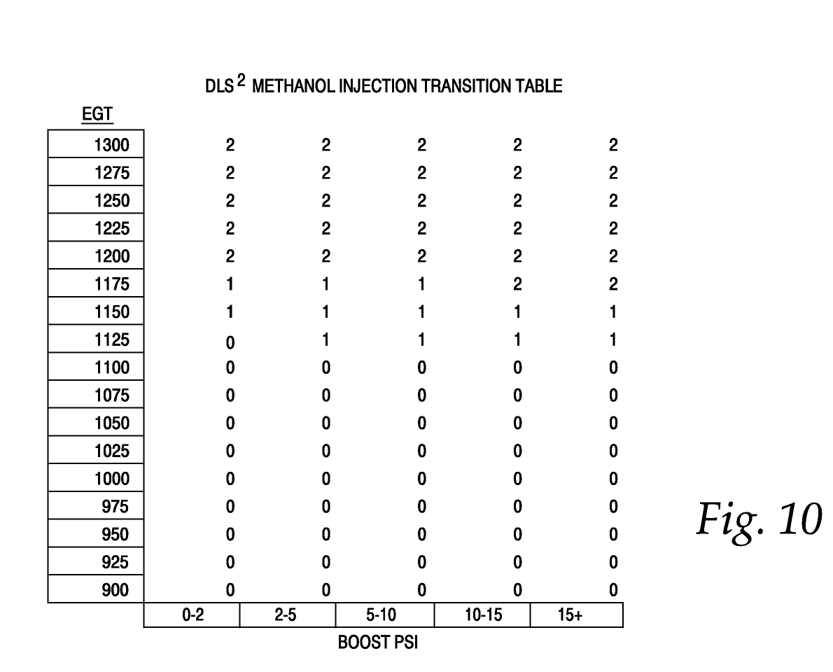

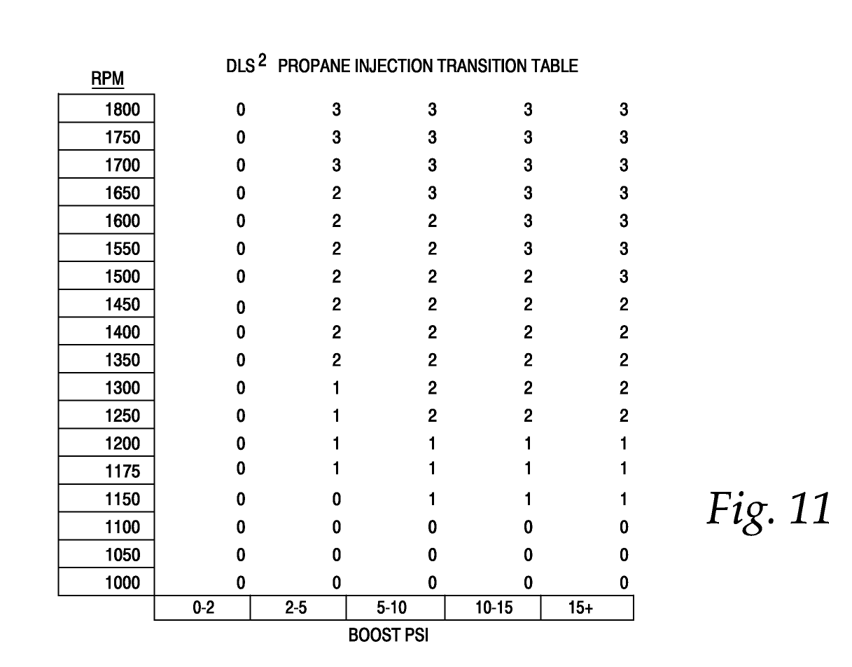

The algorithm may involve the use of look-up tables, for example, without limitation, the look-up tables shown in FIGS. 10 and 11. The methanol injection look up table of FIG. 10 indicates stage of methanol injection as a function of exhaust gas temperature (EGT) and intake manifold pressure (also referred to herein as boost pressure). Stage 0 indicates no methanol injection, stage 1 indicates methanol injection through a first methanol injector (or stage 1 methanol injector) having a first orifice size, and stage 2 indicates methanol injection through a second methanol injector (or stage 2 methanol injector) having a second orifice size. The second methanol injector orifice size typically would be greater than the first methanol injector orifice size such that the methanol flow rate through the second methanol injector would be greater than the methanol flow rate through the first methanol injector, with other parameters being equal. The methanol look up table does not reflect stage 3 injection. Stage 3 methanol injection could be provided for in a manner similar to stage 3 LP injection, as discussed above.

The LP look up table of FIG. 11 indicates various stages of LP injection as a function of engine rpm and intake manifold pressure. Stage 0 indicates no LP injection, stage 1 indicates LP injection through a first LP injector (or stage 1 LP injector) having a first orifice size, stage 2 indicates LP injection through a second LP injector (or stage 2 LP injector) having a second orifice size, and stage 3 indicates LP injection through both the first and second LP injectors. The second LP injector orifice size could be the same as the first LP injector orifice size or greater than the first LP injector orifice size. The second LP injector orifice size typically would be greater than the first LP injector orifice size such that the LP flow rate through the second LP injector would be greater than the LP flow rate through the first LP injector, with other parameters being equal.

The injection stages set forth in the methanol and LP look up tables are illustrative and not limiting. They could be established as a function of engine size (or displacement), boost pressure, altitude (ambient barometric pressure), ambient temperature, coolant temperature, engine RPM, and/or other parameters.

A look up table could be provided for the ether sub-system in a similar manner.

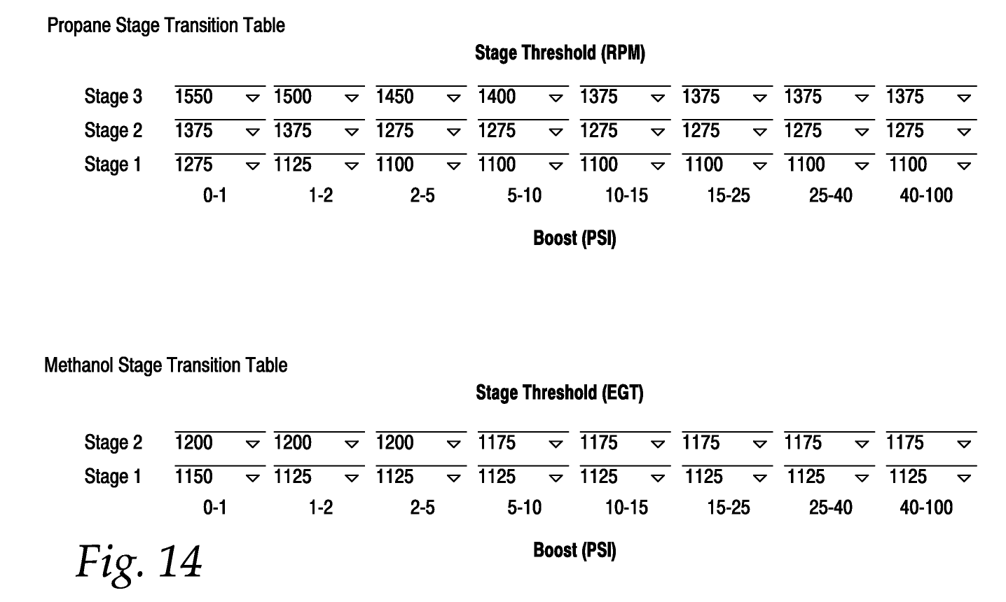

FIG. 14 shows other illustrative forms of propane (LP) and methanol stage transition tables. The propane stage transition table of FIG. 14 shows, in an illustrative, non-limiting embodiment, propane injection stage as a function of RPM and intake manifold pressure. The methanol stage transition table of FIG. 14 shows, in an illustrative, non-limiting embodiment, methanol injection stage as a function of RPM and exhaust gas temperature (EGT). The RPM and EGT values shown or applied in propane stage transition table and the methanol stage transition table, respectively, can be varied as may be desired to achieve a particular level of diesel engine performance.

In an embodiment, the controller 60 could be provided with a software and/or hardware based algorithm that determines a desired additive flow rate based on any or all of the sensed parameters described herein, as well as engine size and/or other factors. Data sampling and processing could be performed at any desired interval to support the operation of the algorithm and the system 12.

Each additive subsystem could be configured to provide additional additive injection stages, for example, by providing additional additive injectors, as discussed above.

In an illustrative embodiment, methanol may be injected, for example, if the controller, based upon input received from one or more of the foregoing sensors, for example, exhaust gas temperature and/or intake manifold pressure, determines that engine combustion temperature exceeds a predetermined threshold. LP may be injected, for example, if the controller, based upon input received from one or more of the foregoing sensors, for example, engine rpm and/or intake manifold pressure determines that engine combustion temperature falls below a predetermined threshold. Methanol and/or LP injection may be based upon other parameters, as well, for example, engine load as might be determined based on one or more of intake manifold pressure and engine rpm.

As suggested above, the ether subsystem may operate at a pressure of about 20-180 psi or a lesser or greater pressure. The LP subsystem may operate at a pressure of about 50-180 psi or a lesser or greater pressure. The ether and LP subsystem operating pressures may be achieved by charging the ether and LP tanks to pressures at least as great as the desired operating pressures. In an embodiment, either or both of the ether and LP subsystems could include an additive pressure booster pump to boost the additive pressure at the additive injector, for example, to a higher pressure than the corresponding additive tank pressure. For example, the LP pump 62 may be provided in the LP subsystem, as discussed above, to boost the LP supply pressure from the LP tank 38 to the LP injectors into this range, as may be necessary or desired. The methanol subsystem may operate at a pressure of about 170-200 psi or a lower or greater pressure. The methanol pump 60 may be provided in the methanol subsystem, as discussed above, to achieve the foregoing methanol subsystem operating pressure. Filters may be provided in connection with any or all of the additive subsystems to filter the respective additive at any point prior to injection. Pressure regulators may be provided in connection with each additive subsystem to regulate the respective additive subsystem's liquid injection and/or operating pressure.

Sensors monitoring the foregoing additive subsystem operating pressures could be configured to trigger an alarm or a shutdown of the overall system 12 or any additive subsystem thereof if any or all of the additive subsystem operating pressures or levels are outside predetermined parameters.

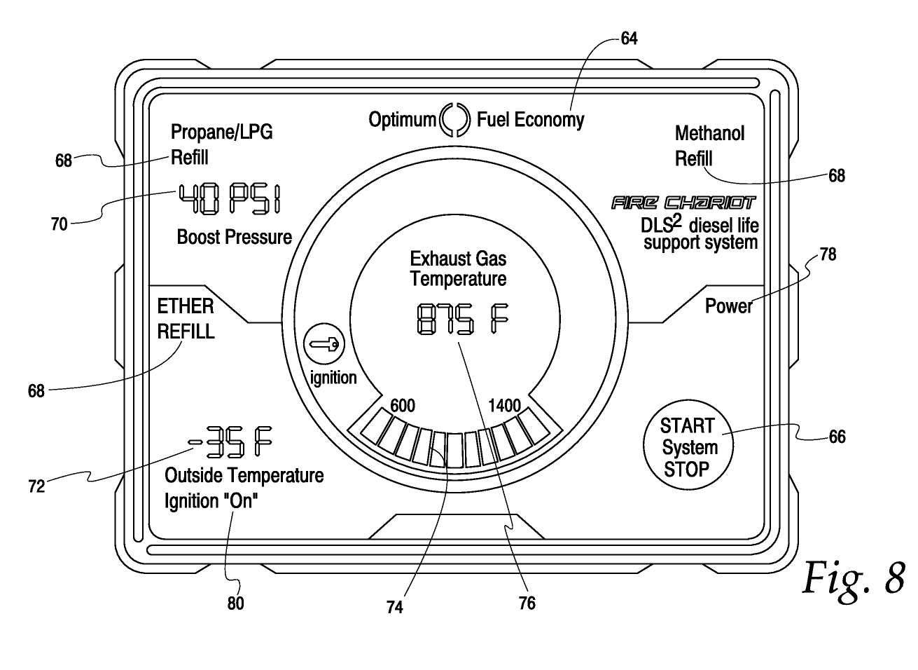

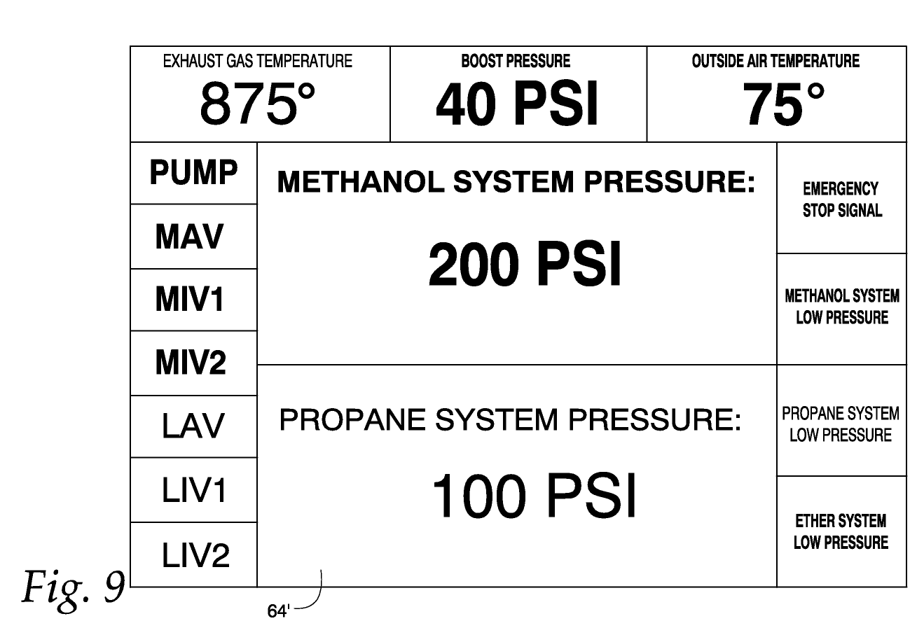

The system 12 could include a control panel and/or display for controlling and/or monitoring the system. FIG. 8 shows an illustrative control/display panel 64 including an on/off switch 66 operable by a user to turn the system on and off. The panel also includes refill indicators 68 indicating low subsystem additive levels, a boost pressure display 70, an ambient air temperature display 72, a tachometer/engine speed display 74, an exhaust gas temperature display 76, a system power status display 78, and an ignition “on” display 80 that may display any desired information. FIG. 9 shows another illustrative panel 64′ having displays for exhaust gas temperature, supercharger boost pressure, ambient air temperature, methanol system pressure, LP system pressure, low additive pressure warnings, methanol pump status and methanol and LP injection valve status. In an embodiment, the foregoing display panel(s) could display, for example, fuel additive tank pressure and/or volume.

As suggested above, the system 12 could be used on a diesel engine truck or tractor. In such an embodiment, the LP tank 38 could be located on the truck's frame, on the body behind the operator's cab or sleeper, or elsewhere on the vehicle. The methanol tank 36 could be located under the engine hood or elsewhere on the vehicle. The ether tank 34 similarly could be located under the engine hood or elsewhere on the vehicle. The tank locations could be determined as a function of environmental conditions in the area surrounding the tanks and the space required to accommodate the tanks. In an illustrative embodiment, the tank locations could be selected so that the additive conduits need not be unnecessarily long. The additive tanks typically would be sized to allow extended operation of the diesel engine and system 12 in terms of mileage, time (for example, engine-hours), and/or other parameters. For example, the ether tank might be sized to support a specified number of engine cold starts without replenishment. The methanol and LP tanks might be sized to permit operation of the system 12 for a duration similar to that supported by the engine's diesel or other primary fuel tanks.

In an illustrative embodiment, the foregoing additives are stored and injected in liquid form. The additives may be atomized or vaporized upon injection into the additive injection module 58. A phase change/expansion may occur post-injection, for example, in the additive injection module 58 and/or intake manifold 18.

The system 12 may be operated in conjunction with the operation of the diesel engine 10 by selectively opening and closing the various additive injection valves. The ether injection valve 40A typically would be opened to facilitate starting the engine 10 when the engine coolant and/or ambient air temperatures are below predetermined thresholds. The ether injection valve 40A could then be closed immediately upon engine start up or once the engine has achieved a stable running condition. The ether injection valve 40A could be opened and closed manually by an operator or automatically based on signals provided thereto by the controller.

The methanol and/or LP injection valves 42A, 44A could be opened and closed manually or automatically by the controller as dictated by the look up tables, the algorithm running on the controller, or otherwise. The quantity and timing of methanol injection and/or LP injection may be selected to control combustion temperatures, and may thereby improve the emissions performance of the diesel engine. Also, the quantity and timing of LP injection may be selected to improve the combustion of the diesel fuel or other fuel provided by the fuel system, and may thereby improve the operating efficiency, power, and/or emissions performance of the diesel engine.

The diesel engine 10 may be operated conventionally with the system 12 or a portion or portions thereof turned off or otherwise disabled (for example, as a result of depletion of any or all of the additives).

The embodiments shown and described herein are illustrative and not limiting. One skilled in the art would recognize that features shown in connection one embodiment could be combined with features of another embodiment and that aspects of the embodiments shown and discussed herein could be modified without departure from the scope of the appended claims.

1. A system comprising:
an additive injection module configured for installation in a combustion air intake system of a diesel engine, the additive injection module defining an interior region;
a first additive subsystem including a first additive storage tank, a first additive conduit coupled to said first additive storage tank in fluid communication, and a first additive injector coupled to said first additive conduit in fluid communication, the first additive injector in fluid communication with the interior region of the additive injection module;
a second additive subsystem including a second additive storage tank, a second additive conduit coupled to said second additive storage tank in fluid communication, and a second additive injector coupled to said second additive conduit in fluid communication, the second additive injector in fluid communication with the interior region of the additive injection module:
a third additive subsystem including a third additive storage tank, a third additive conduit coupled to said third additive storage tank in fluid communication, and a third additive injector coupled to said third additive conduit in fluid communication, the third additive injector in fluid communication with the interior region of the additive injection module;
each of the additive injectors comprising an injection valve that may be selectively opened and closed to control flow of the respective additive to the interior region of the additive injection module.

2. The system of claim 1 wherein the first additive subsystem is an ether subsystem, the second additive subsystem is a methanol subsystem, and the third additive subsystem is an LP subsystem.

3. The system of claim 2, at least one of the methanol and LP subsystems further comprising a second injector.

4. The system of claim 2, at least one of the methanol and LP subsystems further comprising second and third injectors.

5. The system of claim 1 further comprising an electronic controller configured to provide on and off signals to the injectors to selectively operate the injectors between on and off states according to a predetermined algorithm.

6. The system of claim 5 wherein the controller further is configured to receive signals from one or more sensors detecting operating parameters of an engine and/or an environment in which the engine is located.

7. The system of claim 6 wherein the controller provides the on and off signals further according to the operating parameters detected by the sensors.

8. The system of claim 6 wherein the algorithm comprises look up tables specifying a manner of providing on and off signals to the injectors as a function of the operating parameters detected by the sensors.

9. The system of claim 1 in combination with the diesel engine.

10. A diesel engine combustion and temperature management system comprising:
an additive injection module configured for installation in a combustion air intake system of the diesel engine, the additive injection module defining an interior region;
a first additive subsystem including a first additive storage tank, a first additive conduit coupled to said first additive storage tank in fluid communication, and a first additive injector coupled to said first additive conduit in fluid communication, the first additive injector in fluid communication with the interior region of the additive injection module;
a second additive subsystem including a second additive storage tank, a second additive conduit coupled to said second additive storage tank in fluid communication, and a second additive injector coupled to said second additive conduit in fluid communication, the second additive injector in fluid communication with the interior region of the additive injection module;
a third additive subsystem including a third additive storage tank, a third additive conduit coupled to said third additive storage tank in fluid communication, and a third additive injector coupled to said third additive conduit in fluid communication, the third additive injector in fluid communication with the interior region of the additive injection module;
each of the additive injectors comprising an injection valve that may be selectively opened and closed to control flow of the respective additive to the interior region of the additive injection module; and
an electronic controller configured to provide on and off signals individually to the additive injection valves to selectively open and close the additive injection valves.

11. The system of claim 10 wherein the controller is configured to receive signals indicative of one or more operating parameters of the diesel engine and/or environmental parameters.

12. The system of claim 11 wherein the operating parameters may include one or more of engine rpm, engine coolant temperature, intake manifold pressure, and exhaust gas temperature.

13. The system of claim 12 wherein the environmental parameters may include one of ambient air temperature and ambient air pressure.

14. The system of claim 13 wherein the environmental parameters may further include the other of ambient air temperature and ambient air pressure.

15. The system of claim 11 wherein the controller includes one or more look up tables identifying desired injector status as a function of the received one or more operating parameters and/or environmental parameters.

16. The system of claim 11 wherein the controller includes an algorithm for determining desired injector status as a function of the one or more operating parameters and/or environmental parameters.
